(19) United States
(12) Patent Application Publication
(10) Pub. No.: US 2020/0392785 A1
(43) Pub. Date: Dec. 17, 2020

(54) Shade System with Dual Durometer End Tip

(71) Applicant: InPro Corporation, Muskego, WI (US)

(72) Inventors: Matthew G. Bennett, New Berlin, WI (US); Calvin T. Rupnow, Cedarburg, WI (US)

(21) Appl. No.: 16/442,197

(22) Filed: Jun. 14, 2019

(51) Int. Cl. E06B 9/58; E06B 9/42; E06B 9/80

(52) U.S. Cl. CPC E06B 9/581; E06B 2009/805; E06B 9/80; E06B 9/42

(57) ABSTRACT

An end tip configured to travel in a track of a shade system. The end tip includes a first body section having a first portion and a second portion. The first portion is made of a first material having a first hardness, and the second portion is made of a second material having a second hardness. The first hardness is higher than the second hardness. Also disclosed is a shade system including first and second tracks, a shade, and end tips. The end tips are configured to pull out of the tracks when a static force of at least 10 lbs. is applied to the end tips.

### BACKGROUND OF THE INVENTION

The present invention relates generally to the field of shade systems. The present invention relates specifically to shade systems usable in behavioral health facilities.

In behavioral health facilities, some patients are at risk of harming themselves and will use whatever objects that may be around them to that effect. Thus, in behavioral health facilities, structures and components must be designed to substantially limit their ability to be used by patients who may wish to harm themselves. Embodiments of the present invention relate to a shade system that addresses this need in the art.

### SUMMARY OF THE INVENTION

One embodiment of the invention relates to an end tip configured to travel in a track of a shade system. The end tip includes a first body section having a first portion and a second portion. The first portion is made of a first material having a first hardness, and the second portion is made of a second material having a second hardness. The first hardness is higher than the second hardness.

Another embodiment of the invention relates to a shade system. The shade system includes a first track, a second track, a shade having a loop of shade material, a rail contained in the loop of shade material, a first end tip extending from a first side of the rail, and a second end tip extending from a second side of the rail. The first end tip is configured to move along the first track during normal operation, and the second end tip is configured to move along the second track during normal operation. Each of the first end tip and the second end tip includes a first body section having a first portion and a second portion. The first portion is made of a first material having a first hardness, and the second portion is made of a second material having a second hardness. The first hardness is higher than the second hardness. At least one of the first end tip or the second end tip is configured to pull from the respective first track or second track when a static load of at least 10 lbs. is applied to the first end tip or the second end tip.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 depicts a front view of the shade system, according to an exemplary embodiment.

FIG. 2 depicts a plan view of the rail, end tips, and tracks of the shade system, according to an exemplary embodiment.

FIG. 3 depicts a close-up view of a track and end tip of the shade system shown in FIG. 2, according to an exemplary embodiment.

FIG. 4 depicts an end tip and rod, according to an exemplary embodiment.

FIG. 5 depicts just one end tip of the shade system, according to an exemplary embodiment.

FIG. 6 depicts the angled ends of a track and an angled plug at one end of the track of the shade system, according to an exemplary embodiment.

### DETAILED DESCRIPTION

Before turning to the figures, which illustrate the exemplary embodiments in detail, it should be understood that the present invention is not limited to the details or methodology set forth in the description or illustrated in the figures. It should also be understood that the terminology is for the purpose of description only and should not be regarded as limiting.

Generally, embodiments of a shade system are provided. The shade system has a shade carrying a rail with two end tips that move along respective tracks. In order to prevent a patient from using the end tips as a tie-off point from which a length of cord, rope, sheet, etc. can be secured, the end tips are configured to pull out of the track when a weight of at least 10 lbs. is applied to the end tips. In particular, the end tips will pull out of the track even if the weight is a static weight, i.e., the end tips do not require a sudden impulse or dynamic loading to pull out of the track. As will be described below, the end tips are made of two materials with two different hardnesses. A first, softer material allows the end tips to flex when a load is applied so that they pull out of the track when a threshold load is applied. A second, harder material is provided at the tip of the end tip, and the second material provides durability for the end tip as it slides within the track. Additionally, the tracks in which the end tips move are designed to eliminate potential tie-off points and to allow the shade to pull free from the track when a threshold weight is applied. These and other aspects and advantages will be discussed in relation to the embodiments described below.

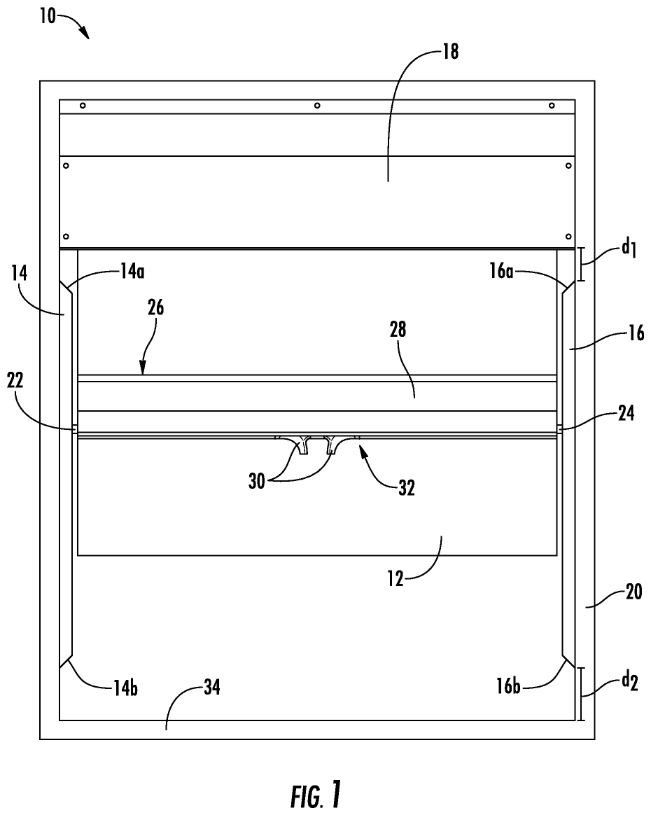

Referring to the FIG. 1, a shade system 10 is provided, which generally includes a shade 12, a first track 14, and a second track 16. As can be seen, the shade 12 is disposed between the first track 14 and the second track 16, and the shade 12 extends downwardly from and retracts upwardly into a security box 18 that houses a system configured to extend and retract the shade 12. As can also be seen in FIG. 1, the security box 18 is arranged above the first track 14 and the second track 16. As depicted in FIG. 1, the shade system 10 is set into or mounted onto a window frame 20. While the shade system 10 is depicted as being inside the window frame 20 in FIG. 1, in other embodiments, the shade system 10 is mounted outside of the window frame 20, e.g., secured to a wall surrounding the window, and in still other embodiments, the shade system 10 is integrated into the window frame 20. Further, those of ordinary skill in the art will understand from the present disclosure that the size and location of the window frame 20 will vary depending on the architectural design choices of the building in which the window frame 20 is situated and the shade system 10 is generally scalable with the dimensions of the window frame 20.

The shade 12 travels upwardly and downwardly along the tracks 14, 16. During normal operation, movement of the shade 12 is restricted to within the plane defined by the tracks 14, 16 by a first end tip 22 and a second end tip 24 that travel along the path defined by the tracks 14, 16. In the embodiment depicted, the shade 12 stops at predetermined stopping points along the tracks 14, 16. In particular, the shade 12 is kept in tension such that the shade 12 would retract but for the end tips 22, 24 abutting projections in the tracks 14, 16 at the predefined stopping points. In embodiments, the projections may be rounded heads of screws that attach the tracks 14, 16 to the window frame 20. In other embodiments, the projections are ramps formed during extrusion of the tracks 14, 16 that allow the end tips 22, 24 to slide downwardly over the ramps but prevent the end tips 22, 24 from sliding upwardly. In order to move past the projections in the tracks 14, 16, the end tips 22, 24 are mechanically engaged with a retraction mechanism in a rail 26 extending across the shade 12. The rail 26 is contained within a loop 28 of material formed on the shade 12. The retraction mechanism is actuated by finger clips 30 that extend from an opening 32 in the loop 28. When the finger clips 30 are pinched together, the retraction mechanism draws the end tips 22, 24 into the rail 26 so that the end tips 22, 24 can pass over the projections in the tracks 14, 16. The finger clips 30 only allow the end tips 22, 24 to retract enough to move past the projections in the tracks 14, 16 but not enough to cause the end tips 22, 24 to pop free from the tracks 14, 16. Retraction mechanisms of this variety are known and incorporated in WebbLok® shades (available from Inpro Corporatin, Muskego, Wis.). Upon raising or lowering the shade 12 to the desired position, the finger clips 30 are released, and a spring within the rail 26 causes the end tips 22, 24 to extend from the rail 26 and engage the projections in the tracks 14, 16 at the new desired stopping point.

In another embodiment, the shade 12 is carried on a continuous roller, which allows the shade to be positioned at any vertical position along the tracks 14, 16. In such an embodiment, the tracks 14, 16 do not contain any projections that define stopping points. Further, because the end tips 22, 24 do not have to pass over any projections in the tracks 14, 16, the rail 26 does not need to contain the retraction mechanism or finger clips 30. In the continuous roller embodiment, the shade 12 still contains the rail to balance against the continuous roller, and the rail 26 also provides a grip to manipulate the vertical position of the shade 12. In the continuous roller embodiment, the end tips 22, 24 confine the movement of the shade 12 to the plane defined by the tracks 14, 16.

Having described the general operation of the shade system 10, the enhancement features of the shade system will be described. As can be seen in FIG. 1, the tracks 14, 16 do not extend the entire length between the security box 18 and the bottom sill 34 of the window frame 20. By not extending the entire length, the end tips 22, 24 of the shade 12 can be pulled out of the tracks 14, 16 through the bottom of the tracks 14, 16 when a sustained weight is suspended from the shade 12 or end tips 22, 24. In embodiments, a first distance d1 is provided between the security box 18 and the top end of each track 14, 16. In embodiments, the first distance d1 is from 1 inches to 3 inches. Further, in embodiments, a second distance d2 is provided between the bottom sill 34 of the window frame 20 and the bottom ends of each track 14, 16. In embodiments, the second distance d2 is from 1 inches to 3 inches.

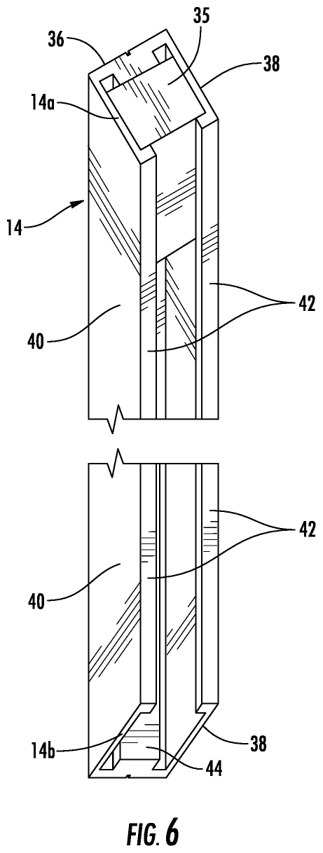

Additionally, as shown in FIGS. 1 and 6, top ends 14a, 16a and bottom ends 14b, 16b of each track 14, 16 are angled (e.g., at an angle of 30°-60°, particularly about 45°) so that a rope, cord, sheet, or other tether cannot be attached to the tracks 14, 16. Further, as shown in FIG. 6, the top end 14a of the first track 14 may include an angled plug 35 to prevent the end tip 22 from exiting the track 14 during normal operation when the shade 12 is raised. The angled plug 35 also helps prevent the top end 14a from being used as a tie-off point. While an angled plug 35 is only shown in relation to the first track 14 in FIG. 6, a substantially identical angled plug 35 may be incorporated into the second track 16. In embodiments, an angled plug 35 may be secured in each of the tracks 14, 16 using an adhesive or by fastening the angled plug 35 to the track 14 (e.g., using a screw).

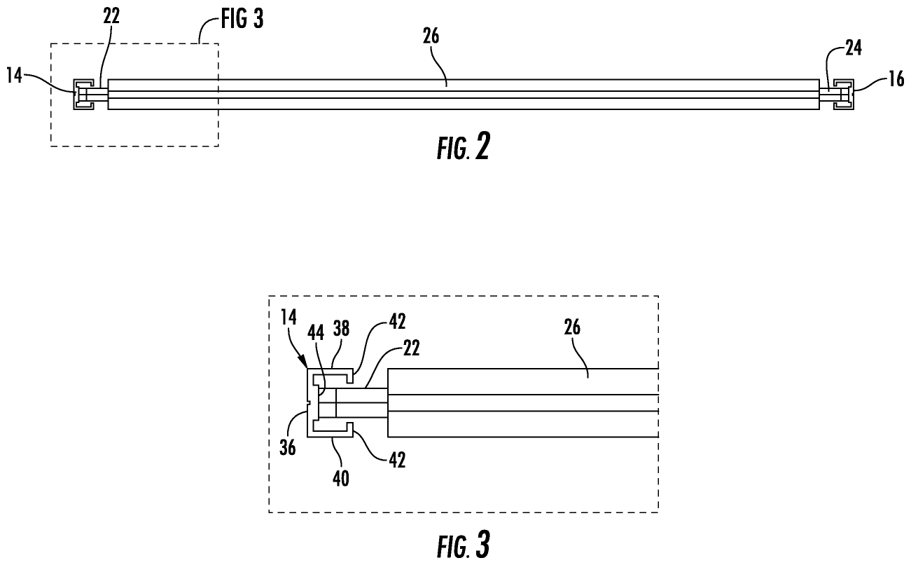

FIG. 2 depicts a view of the rail 26, end tips 22, 24, and tracks 14, 16. As can be seen, the end tips 22, 24 and rail 26 extend substantially the entire span between the tracks 14, 16. FIG. 3 depicts a close-up view of the first track 14 and the first end tip 22, and the following discussion of the first track 14 and the first end tip 22 applies equally to the second track 16 and the second end tip 24. As shown in FIG. 3, the first track 14 has a generally C-shaped cross-section with a sidewall 36, a first extension member 38 and a second extension member 40. The first extension member 38 and the second extension member 40 are arranged substantially perpendicularly to the sidewall 36. In embodiments, one or both of the first extension member 38 and the second extension member 40 each have an inwardly projecting lip 42. The inwardly projecting lips 42 are substantially parallel to the sidewall 36 and help ensure the first end tip 22 travels substantially vertically within the track 14. As can be seen in FIG. 3, a raised travel surface 44 extends from the sidewall 36. The first end tip 22 contacts the travel surface 44 of the sidewall 36 of the track 14.

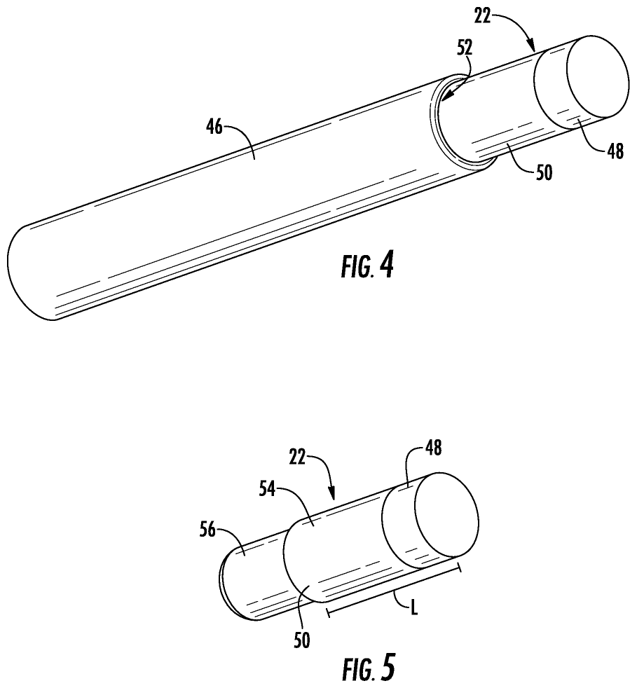

FIG. 3 also shows that the first end tip 22 extends from the rail 26. In particular, the first end tip 22 is mounted on a rod 46 (as shown in FIG. 4) that is inserted into the rail 26. The position of the first end tip 22 in relation to the rail 26 can be adjusted by moving the rod 46 in or out of the rail 26. In an embodiment, the rail 26 includes an internal threaded member, and the rod 46 has an internal bore 52 that can be rotated along the threads to move the rod 46 (and consequently the first end tip 22) in and out of the rail 26. The ability to move the first end tip 22 in relation to the rail 26 facilitates installation of the shade system 10 and ensures that the first end tip 22 will not leave the track 14 during normal operation of the shade system 10.

With reference now to FIG. 4, the rod 46 and the first end tip 22 are shown in greater detail. The second end tip 24 also includes a rod 46 and is substantially identical to the depiction of the first end tip 22 and rod 46 shown in FIG. 4. The first end tips 22 has a first portion 48 having a first hardness and a second portion 50 having a second hardness. The first hardness of the first portion 48 is harder than the second hardness of the second portion 50. Because the first portion 48 of the first end tip 22 moves over the travel surface 44 of the first track 14, the first portion 48 is made of a harder, more wear resistant material. The second portion 50 is configured to bend when a threshold load is applied to the first end tip 22 so that the first end tip 22 is pulled from the first track 14. Thus, the second portion 50 is made from a second, more pliant material having a second hardness. Because of the two different hardnesses, the first end tip 22 may be referred to as “dual durometer” end tip. In embodiments, the second portion 50 is made from a material having a Shore D hardness of 65 or less (and thus, the first portion 48 will have a Shore D hardness of more than 65 in embodiments).

In embodiments, both the first portion 48 and the second portion 50 are made from a polymeric material. In embodiments, the first portion 48 is made from a polyamide (e.g., nylon), acrylonitrile butadiene styrene (ABS), or another similar wear-resistant polymer. In embodiments, the second portion 50 is made from a thermoplastic polyurethane or another similar pliant polymer. In embodiments, the first portion 48 is joined to the second portion 50 using a bonding agent, such as an epoxy. In other embodiments, the first portion 48 may include a male projecting section that is frictionally fit or threaded into female receiving section of the second portion 50. In still another embodiment, the second portion 50 may be overmolded over the first portion 48.

FIG. 5 depicts a view of just the first end tip 22 (the second end tip 24 is substantially identical to the first end tip 22 shown in FIG. 5). The first end tip 22 has a first body section 54 and second body section 56. In the embodiments depicted, the first body section 54 is cylindrical, having a first diameter, and the second body section 56 is also cylindrical, having a second diameter that is smaller than the first diameter. In embodiments, the first body section 54 has a length L of from 0.5 inches to 1.0 inches, more particularly about 0.75 inches. In embodiments in which the first body section 54 is cylindrical, the first body section 54 has a first diameter of from 0.25 inches to 0.5 inches, more particularly about 0.3125 inches (i.e., about 5/16 inches). In embodiments in which the second body section 56 is cylindrical, the second diameter of the second cylindrical section 56 is about 80% to 90% of the first diameter. In embodiments, the first portion 48 comprises from 20% to 40% of the length L of the first cylindrical section 54. While the first body section 54 and the second body section 56 are depicted as being cylindrical, the first body section 54 and the second body section 56 could have different prismatic shapes, such as triangular, rectangular, and other polygonal prisms.

In embodiments, the second cylindrical section 56 is inserted into the internal bore 52 of the rod 46 (as shown in FIG. 4). In embodiments, the second cylindrical section 56 may be joined to the rod 46 using an adhesive to join the second cylindrical section 56 to the rod 46 or inserting a pin through the rod 46 and second cylindrical section 56. In still other embodiments, the second cylindrical section 56 is threaded and is configured to threadably mate with the central bore 52 of the rod 46.

As mentioned above, the end tips 22, 24 as described are designed to pop free from the tracks 14, 16 when loaded at or above a threshold amount. In embodiments, the end tips 22, 24 are configured to pop free from the tracks 14, 16 when placed under a static load of at least 10 lbs. In other embodiments, the end tips 22, 24 are configured to pop free from the tracks 14, 16 when placed under a static load of at least 20 lbs. In still another embodiment, the end tips 22, 24 are configured to pop free from the tracks 14, 16 when placed under a static load of at most 50 lbs. (i.e., the end tips 22, 24 can be placed under a static load of no more than 50 lbs. before popping free from the tracks 14, 16). In other embodiments, the end tips 22, 24 are configured to pop free from the tracks 14, 16 when placed under a static load of at most 35 lbs. The end tips 22, 24 will also typically prop free from the tracks 14, 16 at these threshold amounts if the load is dynamic as opposed to static as generally the application of a dynamic load will cause the end tips 22, 24 to pop free easier than application of a static load.

Advantageously, the end tips 22, 24 are configured to pop free from the tracks 14, 16 in situations where a patient may be attempting to harm himself or herself but not to pop free from the tracks 14, 16 during normal operation. Based on the dual durometer design, the end tips 22, 24 are able to bend or deflect a sufficient amount to allow them to pop free from the tracks 14, 16 but also be replaced on the tracks 14, 16 to resume normal operation. Conventional end tips for certain shade systems were made of a single material, which was selected based on the mechanical wear considerations of the end tips moving within the track. However, these end tips would only pop free from a track upon application of over 100 lbs. of static loading. The end tips 22, 24 according to the present disclosure, however, are made of two materials that address the wear considerations through the use of a harder, wear resistant material in the first portion 48 and that pop free from the tracks 14, 16 upon application of a static load of, e.g., 10 to 50 lbs. through the use of a softer, more pliant material in the second portion 50.

In embodiments, the end tips 22, 24 may be provided to a customer for retrofitting to an existing shade system. Exemplary shade systems that may be retrofit with the end tips 22, 24 include WebbLok® shade system (manufactured by Inpro Corporation, Muskego, Wis.). In embodiments, the end tips 22, 24 may be provided alone for insertion into the rods 46 of the existing shade system, or in other embodiments, the end tips 22, 24 may each be provided with a rod 46 for insertion into the rail 26 of the existing shade system.

In various exemplary embodiments, the relative dimensions, including angles, lengths and radii, as shown in the Figures are to scale. Actual measurements of the Figures will disclose relative dimensions and angles of the various exemplary embodiments. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An end tip configured to travel in a track of a shade system, comprising:
a first body section comprising a first portion and a second portion, the first portion comprising a first material having a first hardness and the second portion comprising a second material having a second hardness;
wherein the first hardness is higher than the second hardness.

2. The end tip of claim 1, wherein the first portion has a first length that is from 20% to 40% of a total length of the first body section.

3. The end tip of claim 2, wherein the total length of the first body section is from 0.5 inches to 1 inch.

4. The end tip of claim 1, wherein the second portion is overmolded over the first portion.

5. The end tip of claim 1, wherein the first material comprises at least one of a polyamide or acrylonitrile butadiene styrene.

6. The end tip of claim 1, wherein the second material comprises a thermoplastic polyurethane.

7. The end tip of claim 1, further comprising a second body section, wherein the first body section is cylindrical and has a first diameter, wherein the second body section is cylindrical and has a second diameter, and wherein the second diameter is less than the first diameter.

8. The end tip of claim 1, further comprising a second body section and a rod, wherein the second body section is configured to be received into a central bore of the rod.

9. The end tip of claim 1, wherein the second hardness is a Shore D hardness of no more than 65.

10. A shade system, comprising:
a first track;
a second track;
a shade having a loop of shade material;
a rail contained in the loop of shade material;
a first end tip extending from a first side of the rail; and
a second end tip extending from a second side of the rail;
wherein the first end tip is configured to move along the first track during normal operation and the second end tip is configured to move along the second track during normal operation;
wherein each of the first end tip and the second end tip comprises a first body section comprising a first portion and a second portion, the first portion comprising a first material having a first hardness and the second portion comprising a second material having a second hardness, wherein the first hardness is higher than the second hardness; and
wherein at least one of the first end tip or the second end tip is configured to pull from the respective first track or second track when a static load of at least 10 lbs. is applied to the first end tip or the second end tip.

11. The shade system of claim 10, wherein the shade system is installed in a window frame having a bottom sill and wherein first ends of the first track and the second track in proximity to the bottom sill are spaced a first distance of at least 1 inch from the bottom sill.

12. The shade system of claim 11, wherein the shade is carried on a roller contained in a security box, wherein second ends of the first track and the second track in proximity to the security box are spaced at a second distance of at least 1 inch from the security box.

13. The shade system of claim 11, wherein the first ends of the first track and the second track in proximity to the bottom sill are angled.

14. The shade system of claim 13, wherein second ends of the first track and the second track distal from the first ends are angled.

15. The shade system of claim 14, wherein an angled plug is contained in each of the first track and the second track at the second ends of the first track and the second track.

16. The shade system of claim 10, wherein the second hardness is a Shore D hardness of no more than 65.

17. The shade system of claim 16, wherein the first material comprises at least one of a polyamide or an acrylonitirile butadiene styrene and wherein the second material comprises a thermoplastic polyurethane.

18. The shade system of claim 10, wherein the first portion has a first length that is from 20% to 40% of a total length of the first body section and wherein the total length of the first body section is from 0.5 inches to 1 inch.

19. The shade system of claim 10, wherein the first track comprises a first plurality of projections and the second track comprises a second plurality of projections and wherein the first end tip abuts one of the first plurality of projections and the second end tip abuts one of the second plurality of projections to hold the shade at a desired level.

20. The shade system of claim 19, wherein the rail comprises a retraction mechanism for drawing the first end tip into the first side of the rail and the second end tip into the second end of the rail so that the first end tip and the second end tip are able to move past the ones of the first plurality of projections and the second plurality of projections to move the shade to a new level.
